(19) United States
(12) Patent Application Publication
(10) Pub. No.: US 2008/0189495 A1
(43) Pub. Date: Aug. 7, 2008

(54) METHOD FOR REESTABLISHING HOTNESS OF PAGES

(76) Inventors: Gerald Francis McBrearty, Austin, TX (US); Shawn Patrick Mullen, Buda, TX (US); Jessica Carol Murillo, Round Rock, TX (US); Johnny Meng-Han Shieh, Austin, TX (US)

Correspondence Address: IBM CORP (YA);C/O YEE & ASSOCIATES PC, P.O. BOX 802333, DALLAS, TX, 75380, US

(21) Appl. No.: 11/670,445

(22) Filed: Feb. 2, 2007

(51) Int. Cl. G06F 12/16; G06F 12/00

(52) U.S. Cl. 711/160; 711/161; 711/E12.103; 711/E12.001

(57) ABSTRACT

A computer implemented method, an apparatus, and a computer usable program product are provided for reestablishing the hotness, or the retention priority, of a page. When a page is paged out of memory, the page's then-current retention priority is saved. When the page is paged in again later, the retention priority of the page is updated to the retention priority that was saved at or before the time the page was last paged out.

### BACKGROUND OF THE INVENTION

1. Field of the Invention

The present invention relates generally to an improved data processing system, and in particular, to a computer implemented method, an apparatus, and a computer usable program code for memory management in a data processing system. Still more particularly, the present invention relates to a computer implemented method, an apparatus, and a computer usable program code for reestablishing hotness of memory pages that have been paged out and are subsequently paged back in.

2. Description of the Related Art

In a data processing system, the currently running applications store their data in the memory of the data processing system. Typically, the memory in a data processing system is smaller than the total data needed by all the running applications. As a result, the operating system loads data into the memory on an as-needed basis, and removes data from the memory that is not immediately needed by an application.

The data in the memory is typically organized in pages. A page is a specified size of data that is loaded or removed as a unit. The process of loading a page of data into the memory is called page in, or paging in, and the process of removing or vacating a page from the memory is called page out, or paging out. Collectively, the processes of paging in and paging out are called “paging”. Pages are paged in and paged out of memory utilizing paging space. Paging space is the space for storing the pages that are expected to be paged in or paged out from the memory. The paging space can exist on a storage device, such as a hard disk, or in another region of the memory.

Paging can occur between the memory and the paging space, or the processor cache and the memory. As described above, the memory is smaller than all the data needed by all the running applications. Processor cache, also known simply as the cache, is a much faster, but even smaller than the memory. This cache is typically built into the processor of a data processing system. Cache is used for paging in and paging out the pages from memory that the processor expects to need while running an application. Hence, the operating system moves the data needed by the running applications from paging space to the memory, from the memory to the cache, and back along the same path, for managing the available memory and cache. This memory management ensures that the running applications have the necessary data available to them despite the limited memory and cache spaces, which are smaller than the size of all the data needed by all the running applications.

While a page is in memory or cache, the page may be accessed numerous times. A page that has been recently accessed is deemed a “hot” page, whereas a page that has not been accessed for a period of time is deemed a “cold” page. Hotness and coldness of memory and cache pages is relative among the pages currently loaded. For example, a page that has been accessed ten times in the last one hundred milliseconds is hotter than a page that has been accessed only five times in that period. However, the page that has been accessed five times in that period is hotter than a page that has been accessed only once or not at all in the same period. Conversely, the page that has been accessed only once is colder than the page that has been accessed five times in a given period.

### SUMMARY OF THE INVENTION

The illustrative embodiments provide a computer implemented method, an apparatus, and a computer usable program product for reestablishing the retention priority of a page. The past retention priority of a page is saved, the past retention priority being the retention priority of the page prior to the time the page is paged out. The page is paged in at a later time. When the page is paged in, the retention priority of the page is updated to be the past retention priority of the page.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary block diagram of a data processing environment in which illustrative embodiments may be implemented;

FIG. 2 is a block diagram of a memory configuration that employs paging in accordance with an illustrative embodiment;

FIG. 3 is a page table in accordance with an illustrative embodiment;

FIG. 4 is a page table in accordance with another illustrative embodiment;

FIG. 5 is a block diagram of a page in accordance with an illustrative embodiment;

FIG. 6 is a block diagram of a memory in accordance with an illustrative embodiment; and

FIG. 7 is a block diagram of a memory in accordance with another illustrative embodiment.

### DETAILED DESCRIPTION OF THE PREFERRED EMBODIMENT

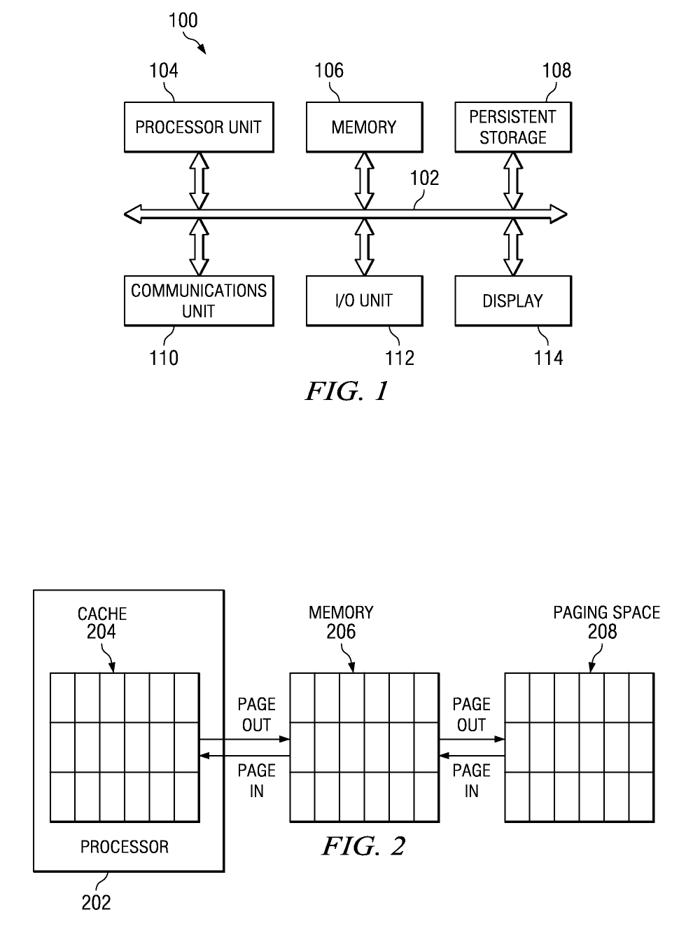

With reference now to the figures and in particular with reference to FIG. 1, an exemplary diagram of a data processing environment is provided in which illustrative embodiments may be implemented. It should be appreciated that FIG. 1 is only exemplary and is not intended to assert or imply any limitation with regard to the environments in which different embodiments may be implemented. Many modifications to the depicted environments may be made.

Turning now to FIG. 1, a diagram of a data processing system is depicted in accordance with an illustrative embodiment. In this illustrative example, data processing system 100 includes communications fabric 102, which provides communications between processor unit 104, memory 106, persistent storage 108, communications unit 110, I/O unit 112, and display 114.

Processor unit 104 serves to execute instructions for software that may be loaded into memory 106. Processor unit 104 may be a set of one or more processors or may be a multi-processor core, depending on the particular implementation. Further, processor unit 106 may be implemented using one or more heterogeneous processor systems in which a main processor is present with secondary processors on a single chip. Memory 106, in these examples, may be, for example, a random access memory. Persistent storage 108 may take various forms depending on the particular implementation. For example, persistent storage 108 may be, for example, a hard drive, a flash memory, a rewritable optical disk, a rewritable magnetic tape, or some combination of the above.

Communications unit 110, in these examples, provides for communications with other data processing systems or devices. In these examples, communications unit 110 is a network interface card. I/O unit 112 allows for input and output of data with other devices that may be connected to data processing system 100. For example, I/O unit 112 may provide a connection for user input though a keyboard and mouse. Further, I/O unit 112 may send output to a printer. Display 114 provides a mechanism to display information to a user.

Instructions for the operating system, the object-oriented programming system, and applications or programs are located on persistent storage 108. These instructions may be loaded into memory 106 for execution by processor unit 104. The processes of the different embodiments may be performed by processor unit 104 using computer implemented instructions, which may be located in a memory, such as memory 106.

FIG. 1 is intended as an example, and not as an architectural limitation for different embodiments. The hardware in FIG. 1 may vary depending on the implementation. Other internal hardware or peripheral devices, such as flash memory, equivalent non-volatile memory, or optical disk drives and the like, may be used in addition to or in place of the hardware depicted in FIG. 1. In addition, the processes of the illustrative embodiments may be applied to a multiprocessor data processing system.

In some illustrative examples, data processing system 100 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course, the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 106, or a cache such as found in north bridge and memory controller hub. A processing unit may include one or more processors or CPUs. The depicted examples in FIG. 1 and above-described examples are not meant to imply architectural limitations. For example, data processing system 100 also may be a tablet computer, laptop computer, or telephone device in addition to taking the form of a PDA.

Pages of data are paged in and out between a paging space and a system memory, between the system memory and the processor cache, and many other data storage configurations. The paging space is a storage area for pages. A paging space may be, for example, a virtual memory, such as an allocated space on a hard disk, or other memory device. For the sake of clarity of description, the memory is used for illustrating the illustrative embodiments described. The illustrative embodiments are similarly applicable to the cache as well as the paging space.

While a page is in memory, the page may be accessed numerous times. A page that has been recently accessed is deemed a “hot” page, whereas a page that has not been accessed for a period of time is deemed a “cold” page. Hotness and coldness of memory and cache pages is relative among the pages currently loaded. For example, a page that has been accessed ten times in the last one hundred milliseconds is hotter than a page that has been accessed only five times in that period. However, the page that has been accessed five times in that period is hotter than a page that has been accessed only once or not at all in the same period. Conversely, the page that has been accessed only once is colder than the page that has been accessed five times in a given period.

The hotness or coldness of a page is determined relative to other loaded pages, based on the number of accesses to those pages in a specified period of time. Consequently, a data processing system can maintain multiple levels of hotness or coldness for the pages. For example, a data processing system could simply consider all pages accessed ten or more times in one hundred milliseconds to be hot pages, and the rest to be cold pages.

Alternatively, a data processing system could have hundreds of levels of hotness. For example, a data processing system could have 0-255 levels of hotness, 255 being the hottest degree of hotness, and 0 being the coldest degree of hotness. Such a data processing system could consider all pages accessed one thousand times or more in one second to be pages with the highest degree of hotness, to wit, 255. Similarly, all pages accessed between nine hundred times and nine hundred and ninety nine times could have the hotness degree of 254. The data processing system could assign various degrees of hotness to pages with other ranges of accesses in this manner.

These are only a few examples of degrees of hotness and manner of assigning hotness, used here for the purpose of illustration. Other manners of assigning degrees of hotness to pages, as well as other ranges of degrees of hotness are possible and easily conceived from this disclosure.

One reason for paging in and out pages is to free up memory for pages of data that are not in the memory yet, but are needed by the running applications. Logically, the best candidate pages for paging out are the cold pages, that is, the pages that have been accessed less number of times compared to other pages loaded in the memory. Likewise, the best candidate pages to retain in the memory are the hot pages, that is, the pages that have been accessed more than other pages loaded in the memory, because they are likely to be needed again soon. In other words, degrees of hotness of pages in the memory are the pages' priority for retention in the memory and paged out from the memory. Therefore, the hotness of a page is the page's retention priority.

Presently, the hotness or coldness of a page is established after the page is paged in. When the page is paged out, the information about the hotness or coldness of the page is lost and must be reestablished when the page is paged back in.

The illustrative embodiments recognize that this loss of information about the hotness or coldness of the page affects the running applications because the hotness of the page can be determined only after a period of time has passed, and the page has been accessed a number of times to enable that determination. A page that is paged in but is not hot enough yet can be paged out if a need arises for freeing up some memory.

This paging in and out of pages causes the applications needing those pages to slow down, resulting in deterioration of the overall performance of the data processing system. Applications can run for varied periods of time on a data processing system. System administrators can set a running time threshold to distinguish between applications based on their running time. Applications that start and terminate within the running time threshold are called short running applications, or short-lived applications. Similarly, applications that run for longer than the running time threshold are called long running applications.

The illustrative embodiments further recognize that the long running applications are more likely to suffer the described performance deterioration. Long running applications suffer this consequence because their pages may need to remain loaded in the memory for a relatively longer period of time between accesses. As an example, one long running application is an application for simulating a nuclear explosion. The simulation can run for several days or even months to generate the results of the simulation, and requires the pages of application data to be available in memory for a long time.

Compare this example of a long running application and the associated paging requirements to an ordinary web browsing application, which typically runs for a much shorter period of time. A web browsing application typically spends even shorter periods of time on a particular displayed web content, may briefly use a data page, and may never use a paged out page again. Although a short-lived application may also suffer performance degradation from the paging activity, the affects of paging are more pronounced and readily observable in long running applications.

The illustrative embodiments provide a computer implemented method, an apparatus, and a computer usable program product for reestablishing the hotness of a page. The illustrative embodiments are described herein with respect to long running applications for illustrating the relevant implementation details. However, the illustrative embodiments are useful for short-lived applications as well long running applications, and are not intended to be limited to long running applications alone.

Furthermore, while the illustrative embodiments are described herein with respect to the system memory and the processor cache, such description is only exemplary and not intended to be limited to only the described data paging configurations. Other implementations where data is paged in and out of other data storage spaces, such as an embedded peripheral memory, for example a printer memory, will also benefit similarly from the illustrative embodiments.

With reference now to FIG. 2, a block diagram of a memory configuration that employs paging is depicted in accordance with an illustrative embodiment. The depicted memory configuration can be implemented using data processing system 100 in FIG. 1. Processor 202, such as processor 104 in FIG. 1, includes the depicted processor cache 204. Memory 206 can be implemented using memory 106 in FIG. 1. Paging space 208 can be implemented using persistent storage 108 in FIG. 1, which may be an allocated space on a hard disk.

Pages of data are paged in from paging space 208 to memory 206, and from memory 206 to cache 204 as needed by an application running on the data processing system. Both steps of paging in may not occur together. For example, a page may be paged in from the paging space to the memory and may not be paged into the cache until later.

When a page is not needed, the page is paged out from cache 204 to memory 206, and from memory 206 to paging space 208. Both steps of paging out may not occur together. For example, a page may be paged out from the cache to the memory and may not be paged out to the paging space until later.

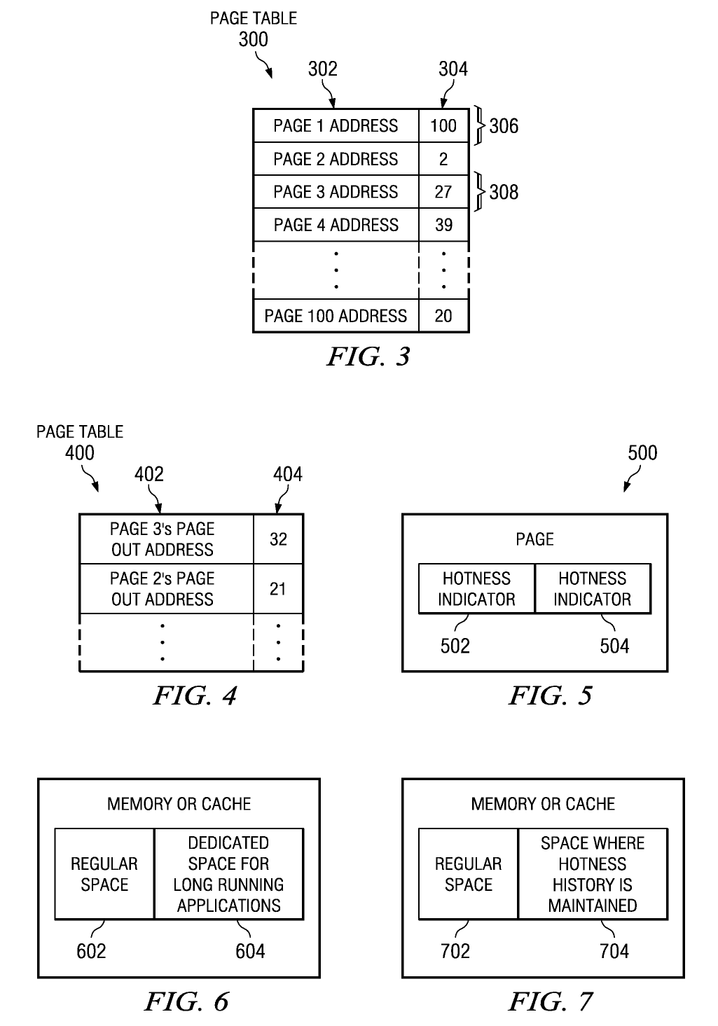

With reference now to FIG. 3, a page table is depicted in accordance with an illustrative embodiment. Page table 300 is a table of memory pages used by a memory manager to manage the memory, such as memory 206 in FIG. 2. A memory manager is a part of an operating system that processes requests for memory space, and allocates and deallocates blocks of memory in accordance with those requests. Among other information maintained in the page table, the memory manager tracks the number of accesses to each page currently in memory, in association with an identification of each page.

Page table 300 shows column 302 containing the addresses of the pages presently in the memory. Page table 300 also contains column 304 containing the number of accesses to the page identified by the corresponding address in column 302 within a specified period. Entries in column 304 reflect the hotness of the corresponding page.

In the depicted page table, the entry in row 306 shows that the page at page 1 address has been accessed 100 times in the specified period, whereas, the entry in row 308 shows the page at page 3 address has been accessed 27 times in the same period. Consequently, the page at page 3 address is colder than the page at page 1 address. The page at page 1 address is the hottest page in the depicted exemplary entries in page table 300.

Note that the illustration of page table 300 is only exemplary, is intended to show a relationship between a page in the memory and the page's hotness, and is not intended to be limiting on the illustrative embodiments. Different implementations of the page table may identify the pages in the memory differently and track their hotness based on a different criterion, such as by the duration of a page in the memory. Regardless, the function of those implementations of the page table remains unchanged for the purpose of the illustrative embodiments, namely, for showing hotness of the pages in the memory. Furthermore, the page table can similarly show the hotness of the pages in the cache, such as cache 204 in FIG. 2.

With reference now to FIG. 4, a page table is depicted in accordance with an illustrative embodiment. Page table 400 is a table of paged out pages used by a memory manager to retain the hotness information of paged out pages.

Page table 400 shows column 402 containing the addresses of the pages that have been paged out. In the case of a page that has been paged out from the cache to the memory, the address may be the address of the page in the memory. In the case of a page that has been paged out from the memory to the paging space, the address may be the address of the page in the paging space.

Page table 400 also contains column 404 containing the number of accesses to the page identified by the corresponding address in column 402 within a specified period before the page was paged out. Entries in column 404 reflect the hotness of the corresponding page at the time of paging out. The entries in column 404 represent the past hotness, or the hotness history, of a page once the page is paged out.

Note that the illustration of page table 400 is only exemplary, is intended to show a relationship between a paged out page and the page's hotness relative to other pages at the time of paging out, and is not intended to be limiting on the illustrative embodiments. Different implementations of the page table can identify the paged out pages differently and track their hotness based on a different criterion, such as by the duration for which the page was in the memory. Regardless, the function of those implementations of the page table remains unchanged for the purpose of the illustrative embodiments, namely, for showing hotness of the paged out pages at the time of paging out from the memory. Furthermore, the page table can similarly show the hotness of the pages at the time of paging out from a processor cache, such as cache 204 in FIG. 2.

In one exemplary situation, a memory manager may force a relatively hot page to be paged out if there is a sudden spike in the demand for memory space, such as from starting a short-lived application. According to an illustrative embodiment with an implementation of page tables 300 and 400, a memory manager can retain the hotness information of pages currently in the memory as well as the hotness of pages that were paged out from the memory. The information in page tables 300 and 400 in FIGS. 3 and 4 allows the memory manager to page in hot pages that were paged out when memory space becomes available, such as when the short-lived application has terminated.

With reference now to FIG. 5, a block diagram of a page is depicted in accordance with an illustrative embodiment. Page 500 is an illustration of a data page residing in the memory, such as memory 206 in FIG. 2; in the cache, such as cache 204 in FIG. 2; or in the paging space, such as paging space 208 in FIG. 2.

In an alternate implementation, an indication of the hotness of the page can be embedded in the page itself. The illustrated page 500 shows hotness indicators 502 and 504, which are data fields used for storing and updating the hotness information of the page. Because the hotness of a page is the page's retention priority as described above, the hotness indicators are alternatively called the retention priority indicators.

Therefore, a retention priority of a page in memory could be 255 on an exemplary scale of 0-255, making the page the coldest page in the memory. Alternatively, the retention priority of a page could be 128 on the same exemplary scale, making the page hotter than other pages in the memory with retention priority values of greater than 128, and colder than the pages with retention priority values of lower than 128. The hotness indicators hold the values that represent the hotness of the page, such as described in the above examples.

A data processing system may use any scale of numeric, alphanumeric, or any other appropriate representation of the hotness of a page. Note that one or more hotness indicators may be associated with a single page. For example, a page may have a different hotness in the memory and in the cache, and a separate hotness indicator can be used for each hotness indication.

The hotness indicator is saved with the page at the time the page is paged out, or at a time prior to the page being paged out. This saved hotness, or retention priority, becomes the past hotness, or retention priority of the page. When a page is paged in, the embedded hotness indicator informs the memory manager of the hotness of the page at the time the page was last paged out, in accordance with an illustrative embodiment.

Either the combination of page tables 300 and 400 in FIGS. 3 and 4, or the embedded hotness indicators in page 500 in FIG. 5, may further be applied to only a portion of the memory. For example, either of these techniques may be implemented so that the hotness history of the pages is tracked and reestablished in only a portion of the memory. As another example, either of these techniques may be implemented so that the hotness history of the pages is tracked and reestablished only for memory space designated by a long running application. These exemplary implementations are described only for illustration purposes and are not intended to be limiting on the illustrative embodiments. Many other situations, where selective application of the illustrative embodiments is appropriate, will become apparent to those of ordinary skill in the art from this disclosure.

With reference now to FIG. 6, a block diagram of a memory is depicted in accordance with an illustrative embodiment. A memory, such as memory 206 in FIG. 2, or a cache, such as cache 204 in FIG. 2, is depicted to have two portions. Portion 602 of the memory uses the present technology for tracking the hotness of pages in the memory. Portion 604 of the memory implements the illustrative embodiments described herein. Particularly, in this exemplary illustration, portion 604 of the memory is the memory space designated for use by a long running application, and uses the illustrative embodiments for tracking the hotness history of the pages in that portion of the memory.

With reference now to FIG. 7, a block diagram of a memory is depicted in accordance with an illustrative embodiment. A memory, such as memory 206 in FIG. 2, or a cache, such as cache 204 in FIG. 2, is depicted to have two portions. Portion 702 of the memory uses the present technology for tracking the hotness of pages in the memory. Portion 704 of the memory implements the illustrative embodiments described herein. Particularly, in this exemplary illustration, portion 704 of the memory is the memory space designated for tracking hotness history. Applications that can use the hotness history according to the illustrative embodiments use this portion of the memory for locating their pages.

FIGS. 6 and 7 illustrate exemplary configurations where the illustrative embodiments are implemented to benefit only a part of the memory. Other configurations where the illustrative embodiments are beneficial in this manner will become apparent to those of ordinary skill in the art from this disclosure.

In order to utilize the apportioned implementation of the illustrative embodiments as described with respect to FIGS. 6 and 7 above, applications should be identified as long running or otherwise. As one alternative, an administrator can use an administration user interface to associate a “long running application indicator” with the various applications on the data processing system. The long running application indicator will then indicate to the memory manager that the pages for that application are to be tracked for hotness history and should be located in the portion of the memory that is using the illustrative embodiments.

As another alternative, a long running application can have an attribute embedded in the application's executable code that can indicate the application's nature to the memory manager. The memory manager can then know to locate the pages for that application in the portion of the memory that is using the illustrative embodiments.

As another alternative, a long running application can call an application programming interface (API) when started. The API can be provided by the operating system. The API call can indicate the application's nature to the memory manager. The memory manager can then know to locate the pages for that application in the portion of the memory that is using the illustrative embodiments.

As another alternative, the memory manager could automatically determine the pages of a long running application and mark them for tracking their hotness history. In this alternative, the implementation of the illustrative embodiments could locate such pages in a separate portion of the memory, or track the history of specific pages wherever in the memory they may be.

The above alternative methods for indicating the nature of an application to the memory manager are described only as exemplary and are not intended to be limiting on the illustrative embodiments. Several other alternate methods for indicating the nature of an application to the memory manager will become apparent to those of ordinary skill in the art from this disclosure.

Thus, the illustrative embodiments allow a memory manager to determine the hotness, or retention priority, of a page at the time the page was last paged out. This information is useful in reestablishing the hotness of the page faster based on the page's hotness history. A page being paged in will not be the coldest page at page in, but will have some hotness already associated with the page.

This indication of past hotness allows the memory manager to page in hot pages when space becomes available. The indication also allows long running applications longer access to their hot pages with fewer paged out occurrences.

The illustrative embodiments can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories, which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

The description of the illustrative embodiments has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for reestablishing a retention priority of a page, the computer implemented method comprising:
saving a past retention priority of the page, wherein the past retention priority is the retention priority of the page prior to a time the page is paged out;
performing a page in operation on the page at a later time; and
updating the retention priority of the page to the past retention priority of the page in response to performing the page in operation.

2. The computer implemented method of claim 1, wherein the saving step further comprises:
making an entry in a page table accessible to a memory manager, wherein the entry comprises an identification of the page and the retention priority of the page at the time the page is paged out.

3. The computer implemented method of claim 2, wherein the identification of the page comprises:
an address of the page.

4. The computer implemented method of claim 1, wherein the saving step further comprises:
saving the retention priority of the page within the page using at least one data field within the page designated for saving a retention priority indicator.

5. The computer implemented method of claim 1 wherein the saving and updating steps are performed for pages in a designated area of a memory.

6. The computer implemented method of claim 1 wherein the saving and updating steps are performed for pages belonging to a specific application.

7. The computer implemented method of claim 6 wherein the pages belonging to the specific application are determined by one of a memory manager, and the specific application.

8. The computer implemented method of claim 6 wherein the specific application is identified by one of an administrator, an attribute of the specific application, and a call to an application programming interface by the specific application.

9. A computer usable program product comprising a computer usable medium including computer usable code for reestablishing a retention priority of a page, the computer usable program product comprising:
computer usable code for saving a past retention priority of the page, wherein the past retention priority is the retention priority of the page prior to a time the page is paged out;
computer usable code for performing a page in operation on the page at a later time; and
computer usable code for updating the retention priority of the page to the past retention priority of the page in response to performing the page in operation.

10. The computer usable program product of claim 9, wherein the computer usable code for saving further comprises:
computer usable code for making an entry in a page table accessible to a memory manager, wherein the entry comprises an identification of the page and the retention priority of the page at the time the page is paged out.

11. The computer usable program product of claim 10, wherein the identification of the page comprises:
an address of the page.

12. The computer usable program product of claim 9, wherein the computer usable code for saving further comprises:
computer usable code for saving the retention priority of the page within the page using at least one data field within the page designated for saving a retention priority indicator.

13. The computer usable program product of claim 9, wherein the computer usable code for saving and the computer usable code for updating are executed for pages in a designated area of a memory.

14. The computer usable program product of claim 9, wherein the computer usable code for saving and the computer usable code for updating are executed for pages belonging to a specific application.

15. The computer usable program product of claim 14, wherein the pages belonging to the specific application are determined by one of a memory manager, and the specific application.

16. The computer usable program product of claim 14, wherein the specific application is identified by one of an administrator, an attribute of the specific application, and a call to an application programming interface by the specific application.

17. A data processing system for reestablishing a retention priority of a page, comprising:
a storage device, wherein the storage device stores computer usable program code; and
a processor, wherein the processor executes the computer usable program code, wherein the computer usable program code comprises:
computer usable code for saving a past retention priority of the page, wherein the past retention priority is the retention priority of the page prior to a time the page is paged out;
computer usable code for performing a page in operation on the page at a later time; and
computer usable code for updating the retention priority of the page to the past retention priority of the page in response to performing the page in operation.

18. The data processing system of claim 17, wherein the computer usable code for saving further comprises:
one of computer usable code for making an entry in a page table accessible to a memory manager, wherein the entry comprises an identification of the page and the retention priority of the page at the time the page is paged out, and wherein the identification of the page comprises an address of the page, and computer usable code for saving the retention priority of the page within the page using at least one data field within the page designated for saving a retention priority indicator.

19. The data processing system of claim 17, wherein the computer usable code for saving and the computer usable code for updating are executed for pages in a designated area of a memory.

20. The data processing system of claim 17, wherein the computer usable code for saving and the computer usable code for updating are executed for pages belonging to a specific application, wherein the specific application is identified by one of an administrator, an attribute of the specific application, or a call to an application programming interface by the specific application, and wherein the pages belonging to the specific application are determined by one of a memory manager, and the specific application.
